(19) United States
(12) Patent Application Publication
(10) Pub. No.: US 2003/0102749 A1
(43) Pub. Date: Jun. 5, 2003

(54) Assembly element in an adjustment element which is especially fitted with a small power motor

(76) Inventors: Dieter Kuch, Wohnsitz (DE); Alfred Engelhard, Wohnsitz (DE); Otto Nachbauer, Wohnsitz (DE); Richard Riedel, Wohnsitz (DE)

Correspondence Address: Horst M Kasper, 13 Forest Drive, Warren, NJ, 07059, US

(21) Appl. No.: 10/204,587

(22) PCT Filed: Nov. 30, 2001
(86) PCT No.: PCT/EP01/13993

(30) Foreign Application Priority Data
Dec. 22, 2000 (DE) 10064803.7

(51) Int. Cl. H02K 5/00

(52) U.S. Cl. 310/91

(57) ABSTRACT

In order to fit a motor (12) in a housing (16) for an adjustment element, the motor (12) needs to be only axially introduced into a pot-shaped holding receiver (17). Said receiver (17) is then covered on the drive side by means of an assembly element (21) which is essentially in the form of a ring disk, and which, in order to obtain axial tolerance compensation, is supported opposite the housing by means of a spring arm (28) arranged in a crown-shaped manner. Said assembly element positively engages with the end shield (25) of the motor (12) and with the housing (16), in order to harness the torque. The axial connections (26) between the motor (12) and the assembly element (21) are used simultaneously, in terms of the position, the cross-section and/or depth of contact, for coding the motor classification by the assembly element (21). The geometrically complex, extruded assembly element (21) preferably forms one single part with its spring arms, coding knops or recesses, and supporting legs, is formed from non-electroconductive plastic, and can be fitted with a holding system (32) for a sensor (33), near the passage of the output shaft (14), said sensor being electrically connected to a sensor cable (20) on the assembly element (21).

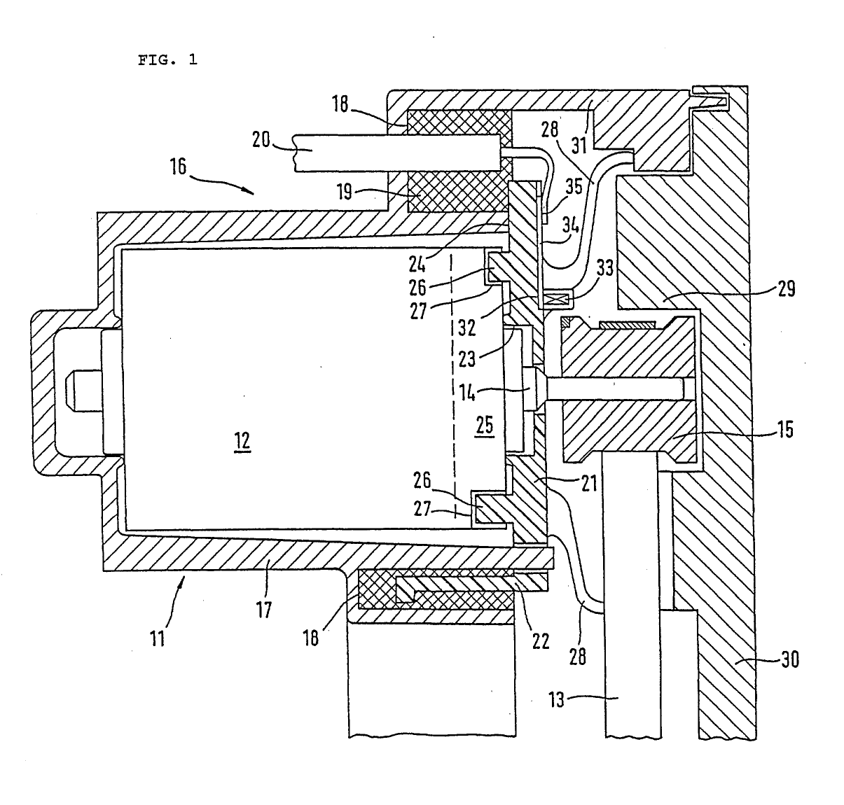

The Invention relates to an assembly element according to the kind of the main claim.

Powerful electric motors are usually equipped with attachment holes disposed in molded stand sockets and oriented perpendicular to the motor axis at the stator casings of the electric motors and less powerful constructed electric motors are frequently equipped with attachment holes in a bearing shell oriented parallel to the motor axis or in a collar surrounding the bearing shell, however the small high-speed direct current low voltage motors of interest predominantly within the framework of the present Invention usually exhibit a simple, essentially cylindrical motor casing without integrating attachment elements. The assembly of the small high-speed direct current low voltage motors can be performed with a rigid clamp or with a flexible strap retainer on a supporting part of the surrounding apparatus construction, which apparatus construction is designated in the following as casing of the servo component. However, no defined axial positioning in the casing is assured based on such incorporation, which is otherwise usually required in view of the cooperation with the following function parts such as a gear following to the motor.

Therefore the technical problem base underlies the present Invention for furnishing an assembly element capable of being applied universally and in particular for the incorporation of small motors, as they are employed with their following step down gears as electromotor server elements in the motor vehicle industry.

This object is achieved by an assembly element of the kind recited in the main claim, which assembly element furnishes equally a balancing of axial production and assembly tolerances including radial centering of the driven side of the motor under supporting against the incorporation surroundings of motor in the casing of the servo component and which assembly element opens up in addition a fixation safe against rotation for receiving of the torque of the motor relative to the surrounding casing including insertion coding.

For this purpose the assembly element according to the present Invention is furnished essentially as -a perforated disk gripping over the driven shaft, wherein the perforated disk is stiff elastically supported against the casing axially and radially in the incorporation surroundings with spring arms protruding perpendicular to the main plane of the perforated disk. This disk is supported fixed against rotation at the casing and can in addition be engaged in a shape matching engagement with the end plate of the motor through projections disposed parallel to the axis of the motor, wherein the motor is prevented from a rotation relative to the casing. This engagement can serve at the same time as a coding in order to assure that the direct current motor is inserted with proper roles relative to the spacial position of the connection clamp terminals into the casing. Certain motors can be coordinated to certain requirements in addition based on this coding. For example, motors can be characterized at the bearing shells with respect to different steps of power or construction or kinds of construction and can be coordinated to corresponding assembly elements.

The respective motor can rest with its essentially cylindrical surrounding casing simply by loose coaxial positioning in a pot shaped receiver narrowing slightly conically inwardly toward the floor for centering. This receiver pot is covered with the assembly element opposite to the floor after the insertion of the servo component. Upset and bendable spring arms extent about a direction parallel to the axis from the assembly element on the outside, at the surface disposed remote relative to the servo component and formed on along a circular line. The spring arms serve for a stiff elastic support relative to the casing and thereby for an axial tolerance balancing with a simultaneous radial centering of the motor on the driven side in the region of the larger diameter of the receiver pot.

The perforated disk covering the receiver pot exhibits several support legs also about disposed axial parallel and oriented preferably opposite to the spring arms and disposed along the edge of the perforated disk, wherein the support legs shape matching engage the casing for torque support. In addition, the disk with knobs or punctures disposed parallel to the axis is in the already recited shape matching engagement fixed against rotation with the neighboring bearing shell of the servo component.

The therefore geometrically complex assembly element is preferably injection molded as a single piece pot of electrically nonconducting plastic with its spring arms, coding knobs, or coding recesses and the support legs and can be further equipped with a support for sensor in the neighborhood of the central opening of the assembly element for a passage through of the drive shaft, wherein the sensor itself is electrically connected to a sensor cable at the assembly element. This sensor cable can be fed from the rearside in an axial parallel direction and can be fixed in a pocket on the outside at the support receiver and force matchingly at the casing, for example through a cast in or by way of an over gripping edge of the assembly element, wherein the over gripping presses in axial direction an upset bush with the cable running through the upset bush.

Reference is made to the further claims and to the following description of an embodiment sketched in the drawing not to scale and being limited to the essential features for complementing and supplementing the disclosure of the invention. The single figure of the drawing shows in an axial longitudinal sectional view the incorporation of a small motor into the casing of a servo component by employing the assembly element according to the present invention.

The motor servo component 11 can comprise a construction unit out of high-speed direct current motor 12 with an immediately attached step down gear. However the motor driven shaft 14 is equipped with a pulley 15 for a toothed belt 13 for driving of a gear mounted staggered in axial parallel direction in the casing 16 in the example shown.

The casing 16 is furnished out of metal or plastic with a pot shaped receiver 17 narrowing to some extent inside for supporting the motor 12. Pockets 18 disposed parallel to the axis and on the driven side open are disposed at the outer contour of the receiver 17 and serve for the reception of support legs 22, wherein the support legs 22 project in a direction approximately perpendicular to the main plane of the assembly element 21 from the essentially punched disk shaped assembly element 21. The support legs 22 are submerged into the locally coordinated pockets 18 when the assembly element 21 with its central opening 23 is placed onto the receiver 17 in axial direction over the protruding shaft 14. The assembly element 21 however passes here only then up to its axial end position in the casing 16, that is approximately to rest against the front edge 24 of the receiver 17, in case the assembly element 21 form matchingly engages at the rearside of the assembly element 21 with the end plate 25 for the driven shaft 14 of the motor 12 on the front side. For this purpose projections 26 disposed in a direction parallel to the axis are furnished in the sketched embodiment, wherein the projections 26 engage flush into coordinated puncture recesses 27 coordinated with respect to position, depth of engagement, and cross-sectional dimensions in case the motor 12 has assumed its predetermined orientation in the casing 16 and the pre-given pairing of motor 12 and assembly element 21 is correct. The pin like projections 26 are furnished at the rear side of the assembly element 21 in the sketched embodiment and the puncture recesses 27 are furnished in the front face of the end plate 25 neighboring to the assembly element 21; however also the projections 26 can be furnished in part or completely on the front side of the end plate 25 (mounted or molded) and the puncture recesses 27 can correspondingly be in the here resting rear side of the assembly element 11.

The support legs 22 can be force matchingly fixed in the pockets 18 with a cast mass. At least one radial projection at the support legs 22, for example the sketched end corner molding, increases the safety against axial changes in position in the casing 16 in case of an axial load of the assembly element 21.

Cable connections to the servo element 11, possibly a feed cable for the motor 12 or, respectively, a sensor cable 20, are advantageously fed in from the rearside in a direction parallel to the axis through the floors of pockets 18 into the region in front of the end plate 25. The cable attachment can be performed with the casting in of the support leg 22 immersed into this pocket 18. The fixation of a cable 20 with an upsetting bush 19 sketched in the drawing is an alternative to casting in. The end of the cable 20 is force matchingly fixed in the coordinated pockets 18 in this case by mounting the assembly element 21 engaging with the support legs 22 in the pockets 18 in an axial direction in front of the opening of the receiver 17 and thereby axially upsetting the bush 19 with a radially protruding edge.

The assembly element 21 carries a crown shaped collar of swiveling in radial direction but functionally essentially oriented in a direction parallel to the axis, attached or molded on, outward bendable however relatively stiff spring arms 28 on the front side disposed away from the servo component 11. The spring arms 28 are supported (as symbolically over drawn in the drawing) in axial direction and in radial direction against a flat projection in the inner jacket case of the assembly opening of the casing 16. The radial support position of the bush like projection 29 engaging into the interior of the crown shaped collar of the spring legs 28 serves for the radial fixation of this support by the flat projection, wherein the bush like projection 29 surrounds coaxially the shaft 14 with its pulley 15 at the radial distance and wherein the projection 29 projects from a support plate 30 onto the assembly element 21.

This support plate 30 supports the casing 16 with its pot shaped receiver 17 by way of pillars 31 disposed parallel to the axis, wherein the pillars 31 for example as sketched rigidly bridge from the pockets 18 over the axial distance of the shaft 14 projecting from the receiver 17. The tolerance balancing relative to the motor 12 and to the assembly element 21 of motor 12 is performed as described through the axial support of the spring arms 28 of the assembly element 21 against the casing 16 of the servo component 11.

A recess can be provided as a support 32 on the front side of the assembly element 11 furnished with the spring arms 28, wherein the support 32 serves possibly for the fixation of a sensor 33, for example a Hall generator, for monitoring the rotation of the pulley 15. Advantageously also a connection conductor 34 between the sensor support 32 and a connection position 35 for the electrical connection of the sensor cable 20 is force matchingly or shape matchingly supported on the front side of the assembly element 21. This connection conductor 24 can here simply be an inserted metal strip, wherein the metal strip serves as a solder connection and at the same time as a heat sink for protection against local thermal overloading of the assembly element 21.

The servo component 11 has to be plugged essentially only through the mounting opening in the casing 16 and through the pot shaped and conically narrowing down receiver 17 for this purpose, whereupon only still the already with a sensor 33 equipped assembly element 21 is to be placed on in axial direction and on an opposite side under axial and radial tensioning onto the casing 16 (and to be connected to a cable 20).

1. Assembly element (21) disposed in an electromotoric servo component (11) furnished with a small motor (12) characterized in that the assembly element (21) is furnished disk shaped with an opening (23) for passing through the drive shaft (14) of the there behind disposed axially resting motor (12) and wherein the assembly element (21) exhibits a collar of projecting spring arms (28) for radial and axial support of the motor (12) disposed about parallel to the axis and crowned like surrounding the opening (23) disposed in the surrounding casing (16) of the servo component (11).

2. Assembly element according to claim 1 characterized in that the spring arms (28) are support against a flat circulating step in the mounting opening of the casing (16).

3. Assembly element according to claim 1 or 2 characterized in that a projection (29) axially engages into the collar of the spring arms (28), wherein the projection (29) opens up about concentricly to the opening (23) toward the motor (12) and wherein the projection (29) grips over the motor shaft (14) under maintaining a radial distance.

4. Assembly element according to one of the preceding claims characterized in that the assembly element is furnished as a cover over a pot shaped receiver (17) for the motor (12).

5. Assembly element according to one of the preceding claims characterized in that at least one support leg (22) is furnished for engaging into a pocket (18), wherein the pocket (18) is furnished at the receiver (17) for the motor (12).

6. Assembly element according to the preceding claim characterized in that the support leg (22) engages about parallel to the axis of the pot shaped receiver (17) into the pockets (18).

7. Assembly element according to one of the preceding claims characterized in that the assembly element projects through the opening of one pocket (18) for an upsetting bush (19) for fixation of a cable (20), wherein the opening is furnished on the outside at a pot shaped receiver (17) for the servo component (11).

8. Assembly element according to one of the preceding claims characterized in that the assembly element is constructed for an axial parallel form matching engagement between the rear side of the assembly element disposed toward the servo component (11) and the neighboring end plates (25) of the servo component (11).

9. Assembly element according to the preceding claim characterized in that the assembly element is formed with shape matching codings between the rear side of the assembly element disposed toward the servo component (11) and the neighboring end plate (25) of the servo component (11).

10. Assembly element according to one of the preceding claims characterized in that the assembly element is equipped with a support (32) for receiving of a sensor (33) in the neighborhood of the central opening (23).

11. Assembly element according to the preceding claim characterized in that the assembly element is equipped with a connection position (35) between the sensor (33) and a sensor cable (20).
